(19) United States
(12) Patent Application Publication
(10) Pub. No.: US 2003/0009490 A1
(43) Pub. Date: Jan. 9, 2003

(54) Information processing apparatus, information processing method, recording medium, program, and electronic-publishing-data providing system

(76) Inventor: Tamaki Maeno, Kanagawa (JP)

Correspondence Address: Jay H. Maioli, Cooper & Dunham LLP, 1185 Avenue of the Americas, New York, NY, 10036, US

(21) Appl. No.: 10/177,905

(22) Filed: Jun. 20, 2002

(30) Foreign Application Priority Data
Jun. 26, 2001 (JP) P2001-192380

(51) Int. Cl. G06F 15/00

(52) U.S. Cl. 707/500

(57) ABSTRACT

Reference dictionary data is described in a markup language such as XML in an area enclosed by <Dic> and </Dic>. The data of each item is placed at an area starting with <Word id=“xxxx”> and ending with </Word>. Each item has an essential keyword described in an area enclosed by <Primary> and </Primary>, and a keyword which should be added, if possible, but is selected depending on the capacity of a recording medium in which dictionary data is recorded, in an area enclosed by <Secondary> and </Secondary>, together with search categories. Secondary keywords may be described in the order of importance in order to facilitate selection. Following the keywords, the title of the item is described between <Title> and </Title>, and then, a body text is described between <Text> and </Text>.

### BACKGROUND OF THE INVENTION

1. Field of the Invention

The present invention relates to information processing apparatuses, information processing methods, recording media, programs, and electronic-publishing-data providing systems, and more particularly, to an information processing apparatus, an information processing method, a recording medium, a program, and an electronic-publishing-data providing system which allow electronic-publishing data having index data formed of most suitable keywords, to be generated within the capacity of a recording medium with the use of reference data described in a predetermined format which facilitates update work.

2. Description of the Related Art

Publication has been conventionally performed by using paper as its main medium in forms of books, newspapers, and magazines. Due to the developments of computers, their extended usage, and widely spread networks, publication with media other than paper, that is, an electronic publication, has been widely used.

The electronic publication is especially suited for publication with a vast amount of information, such as dictionaries, encyclopedias, and illustrated reference books. An encyclopedia of about thirty volumes can be, for example, put in one compact disk read-only memory (CD ROM). The data of dictionaries which have been so far printed on paper is digitized, audio data and moving images in addition to texts and still images are stored in a predetermined recording medium, personal computers, or a predetermined reproduction apparatus. The user can, for example, use a personal computer or a predetermined reproduction apparatus in which dictionary data has been recorded, or in which a recording medium that has recorded dictionary data is mounted to input a desired item to search for desired information and to read the information.

With a rapid spread of the Internet, on-line dictionaries have been widely spread, in which data is stored in a server and users are allowed use the data through the Internet. In addition, since recording media have been made compact and made to have a larger capacity, many compact electronic dictionaries have also been used.

The data of an electronic dictionary is formed, for example, of body data 2 and index data 1 as shown in FIG. 1. The body data 2 includes text data described in the same format as that in paper dictionaries, and items and their meanings are arranged in a predetermined order (for example, in the order of the Japanese syllabary for Japanese-language dictionaries and Japanese encyclopedias, and in the alphabetical order for English-Japanese dictionaries and English dictionaries). The index data 1 is formed of keywords used by the user to search for a desired item among a number of items included in the body data 2, and address data which indicates where the content (item) corresponding to a keyword is described in the body data 2.

In conventional paper dictionaries, the user needs to turn pages to search for the page on which a desired item is described. In electronic dictionaries, when the user inputs a desired item by the use of a keyboard or others, the item is searched for and its content is displayed on a display apparatus.

To generate electronic data corresponding to a dictionary conventionally published by paper and to allow search processing to be executed, for example, the index data 1, described by referring to FIG. 1, needs to be generated correspondingly to the dictionary body data 2. Since a recording medium which stores dictionary data has a limited capacity, however, the amount of electronic-dictionary data needs to be adjusted by the index data 1 because the amount of the body data 2 has been fixed.

In addition, since there is no definite rule for selecting keywords when the index data 1 corresponding to the body data 2 is generated, a person who knows very well about the content of the body data uses a vast amount of time and labor to carefully select keywords while adjusting the amount of data to generate the index data 1.

There are, for example, words which have the same meanings but differ in Japanese katakana notation, such as “daiamondo” and “daiyamondo,” “firumu” and “fuirumu,” and “yuuza” and “yuuzaa,” mainly in loan words. To allow a search operation to be performed (to obtain a search result which the user desires) even if the user inputs such words, it is desired that keywords constituting the index data 1 need to include such words as many as possible. Therefore, to provide the users with an easy-to-use dictionary, it is necessary to independently generate the index data 1 so as to include as many keywords as possible within the capacity of a recording medium which stores dictionary data.

Since the index data 1 is independently generated from the body data 2 in a conventional dictionary, when the body data is corrected, an item in the body data is modified or added, or the address of the body data 2 is changed, addresses in the index data 1, including those of unmodified items, need to be largely modified, and as a result, the entire dictionary data have to be revised.

### SUMMARY OF THE INVENTION

The present invention has been made in consideration of the above situations. An object of the present invention is to generate electronic-publishing data having index data formed of most suitable keywords within the capacity of a recording medium with the use of reference data described in a predetermined format which facilitates update work.

The foregoing object is achieved in one aspect of the present invention through the provision of an information processing apparatus for converting first information described in a predetermined format to second information formed of index data and body data, and for outputting it, including obtaining means for obtaining the first information; extraction means for extracting a plurality of third information corresponding to a keyword and fourth information corresponding to the body data, from the first information obtained by the obtaining means; detection means for detecting the recording capacity of another information processing apparatus or a recording medium to which the second information is to be output; determination means for determining the level of importance for each of the plurality of third information; selection means for selecting third information from the plurality of third information according to the result of detection performed by the detection means and the result of determination performed by the determination means, such that the total amount of the third information and the fourth information is equal to or less than the recording capacity of the another information processing apparatus or the recording medium; generation means for setting the third information selected by the selection means to the index data, and for adding the fourth information thereto to generate the second information; and output means for outputting the second information generated by the generation means to the another information processing apparatus or to the recording medium.

The information processing apparatus may be configured such that the third information is classified in advance by the level of importance, includes predetermined information corresponding to classification, and is included in the first information; and the determination means determines the level of importance of the third information according to the predetermined information included in the third information.

The information processing apparatus may be configured such that the third information is arranged in advance in the descending order of the levels of importance; and the determination means determines the level of importance of the third information according to the order of the third information.

The information processing apparatus may be configured such that the index data is used by the another information processing apparatus, which obtains the second information, for searching the body data; and the third information is classified in advance by the method of search, includes predetermined information corresponding to classification, and is included in the first information.

The first information may be described in a markup language.

The extraction means may extract the plurality of third information and the fourth information from the first information obtained by the obtaining means, according to tag information indicating the type of information, attached to each of the plurality of third information corresponding to the keyword and the fourth information corresponding to the body-data.

The foregoing object is achieved in another aspect of the present invention through the provision of an information processing method for an information processing apparatus which converts first information described in a predetermined format to second information formed of index data and body data, and outputs it, including an obtaining step of obtaining the first information; an extraction step of extracting a plurality of third information corresponding to a keyword and fourth information corresponding to the body data, from the first information obtained by a process in the obtaining step; a detection step of detecting the recording capacity of another information processing apparatus or a recording medium to which the second information is to be output; a determination step of determining the level of importance for each of the plurality of third information; a selection step of selecting third information from the plurality of third information according to the result of detection performed by a process in the detection step and the result of determination performed by a process in the determination step, such that the total amount of the third information and the fourth information is equal to or less than the recording capacity of the another information processing apparatus or the recording medium; a generation step of setting the third information selected by a process in the selection step to the index data, and of adding the fourth information thereto to generate the second information; and an output step of outputting the second information generated by a process in the generation step to the another information processing apparatus or to the recording medium.

The foregoing object is achieved in still another aspect of the present invention through the provision of a recording medium storing a computer-readable program for an information processing apparatus which converts first information described in a predetermined format to second information formed of index data and body data, and outputs it, the program including an obtaining step of obtaining the first information; an extraction step of extracting a plurality of third information corresponding to a keyword and fourth information corresponding to the body data, from the first information obtained by a process in the obtaining step; a detection step of detecting the recording capacity of another information processing apparatus or a recording medium to which the second information is to be output; a determination step of determining the level of importance for each of the plurality of third information; a selection step of selecting third information from the plurality of third information according to the result of detection performed by a process in the detection step and the result of determination performed by a process in the determination step, such that the total amount of the third information and the fourth information is equal to or less than the recording capacity of the another information processing apparatus or the recording medium; a generation step of setting the third information selected by a process in the selection step to the index data, and of adding the fourth information thereto to generate the second information; and an output step of outputting the second information generated by a process in the generation step to the another information processing apparatus or to the recording medium.

The foregoing object is achieved in yet another aspect of the present invention through the provision of a computer-executable program for an information processing apparatus which converts first information described in a predetermined format to second information formed of index data and body data, and outputs it, including an obtaining step of obtaining the first information; an extraction step of extracting a plurality of third information corresponding to a keyword and fourth information corresponding to the body data, from the first information obtained by a process in the obtaining step; a detection step of detecting the recording capacity of another information processing apparatus or a recording medium to which the second information is to be output; a determination step of determining the level of importance for each of the plurality of third information; a selection step of selecting third information from the plurality of third information according to the result of detection performed by a process in the detection step and the result of determination performed by a process in the determination step, such that the total amount of the third information and the fourth information is equal to or less than the recording capacity of the another information processing apparatus or the recording medium; a generation step of setting the third information selected by a process in the selection step to the index data, and of adding the fourth information thereto to generate the second information; and an output step of outputting the second information generated by a process in the generation step to the another information processing apparatus or to the recording medium.

The foregoing object is achieved in still yet another aspect of the present invention through the provision of an electronic-publishing-data providing system including a recording apparatus for recording first information described in a predetermined format; an information processing apparatus for converting the first information described in the predetermined format to second information formed of index data and body data; and a recording medium for receiving and recording the second information sent from the information processing apparatus, wherein the recording apparatus includes first recording means for recording the first information; and output means for outputting the first information recorded by the first recording means, and wherein the first information includes a plurality of items each formed of a plurality of third information corresponding to a keyword and fourth information corresponding to the body data; tag information indicating the type of information is added to the plurality of third information and the fourth information; and the plurality of third information is classified in advance by the level of importance, and includes a predetermined information corresponding to classification, the information processing means includes obtaining means for obtaining the first information from the recording apparatus; extraction means for extracting the plurality of third information and the fourth information according to the tag information, from the first information obtained by the obtaining means; detection means for detecting the recording capacity of the recording medium; determination means for determining the level of importance for each of the plurality of third information according to the predetermined information corresponding to the classification; selection means for selecting third information from the plurality of third information according to the result of detection performed by the detection means and the result of determination performed by the determination means, such that the total amount of the third information and the fourth information is equal to or less than the recording capacity of the recording medium; generation means for setting the third information selected by the selection means to the index data, and for adding the fourth information thereto to generate the second information; and output means for outputting the second information generated by the generation means to the recording medium, and the recording medium includes second recording means for recording the second information output from the output means.

The recording medium may be provided inside another information processing apparatus.

The first information may be described in a markup language.

According to an information processing apparatus, an information processing method, and a program of the present invention, first information is obtained; a plurality of third information corresponding to a keyword and fourth information corresponding to body data are extracted from the obtained first information; the recording capacity of another information processing apparatus or a recording medium to which second information is to be output is detected; the level of importance is determined for each of the plurality of third information; third information is selected according to the result of recording-capacity detection and the result of level determination such that the total amount of the third information and the fourth information is equal to or less than the recording capacity of the another information processing apparatus or the recording medium; the selected third information is set to index data, and the fourth information is attached to the third information to generate the second information; and the generated second information is output to the another information processing apparatus or to the recording medium. Therefore, with the use of reference data described in a predetermined format which facilitates update work, electronic-publishing data having index data formed of most suitable keywords can be generated within the capacity of a recording medium.

According to an electronic-publishing-data providing system, a recording apparatus records first information and outputs the recorded first information, the first information includes a plurality of items, each item is formed of a plurality of third information corresponding to a keyword and fourth information corresponding to body data, tag information indicating the type of information is attached to the plurality of third information and the fourth information, the plurality of third information is classified in advance according to the level of importance, a predetermined information corresponding to classification is added to the plurality of third information, an information processing apparatus obtains the first information from the recording apparatus, extracts the plurality of third information and the fourth information according to the tag information from the obtained first information, detects the recording capacity of a recording medium, determines the level of importance for each of the plurality of third information according to the predetermined information corresponding to the classification, selects third information according to the result of recording-capacity detection and the result of level determination such that the total amount of the third information and the fourth information is equal to or less than the recording capacity of the recording medium, sets the selected third information to index data and adds the fourth information to the third information to generate second information, and outputs the generated second information to the recording medium, and the recording medium records the output second information. Therefore, reference data described in a predetermined format which facilitates update work is generated and recorded, and electronic-publishing data having index data formed of most suitable keywords is generated within the capacity of a recording medium. The data can be provided for the users by various methods.

### BRIEF DESCRIPTION OF THE DRAWINGS

FIG. 1 is a view showing electronic-dictionary data.

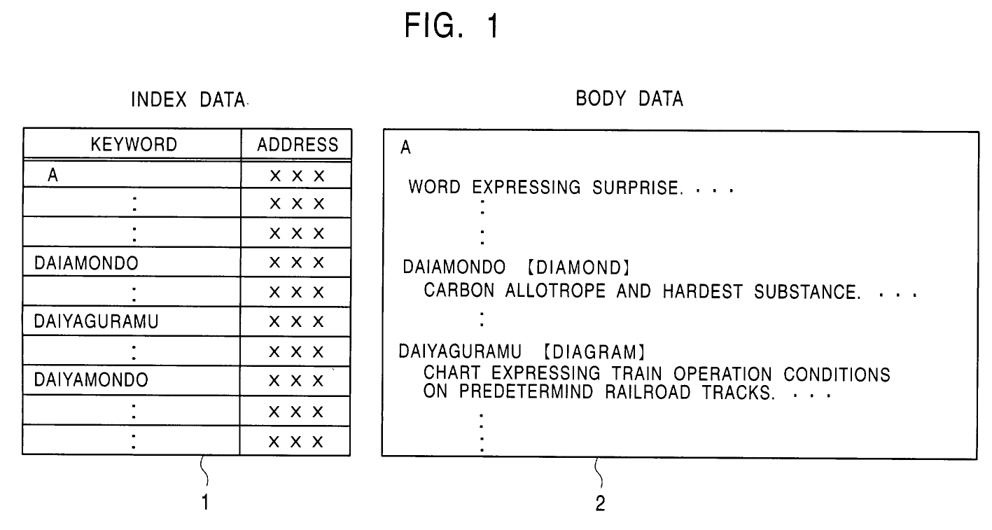

FIG. 2 is a view showing an electronic-dictionary providing system according to an embodiment of the present invention.

FIG. 3 is a block diagram of a personal computer shown in FIG. 2.

FIG. 4 is a block diagram of an electronic dictionary shown in FIG. 2.

FIG. 5 is a block diagram of a PDA shown in FIG. 2.

FIG. 6 is a view showing data recorded in a dictionary data base shown in FIG. 2.

FIG. 7 is a view showing data recorded in the dictionary data base shown in FIG. 2 and different from the data shown in FIG. 6 in structure.

FIG. 8 is a view showing data in a dictionary data base and dictionary data to be generated.

FIG. 9 is a flowchart of dictionary-data conversion processing.

FIG. 10 is a view showing the data structure of dictionary data to be generated.

FIG. 11 is a view showing the data structure of dictionary data to be generated from data in the dictionary data base shown in FIG. 7.

FIG. 12 is a flowchart showing dictionary search processing.

### DESCRIPTION OF THE PREFERRED EMBODIMENT

An embodiment of the present invention will be described below by referring to the drawings.

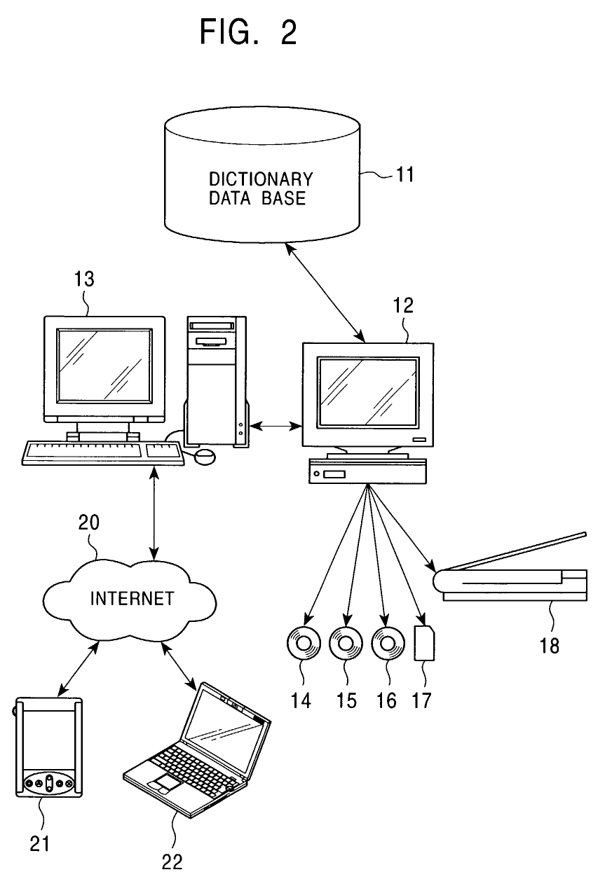

An electronic-dictionary providing system according to an embodiment of the present invention will be described by referring to FIG. 2.

A dictionary data base 11 includes reference dictionary data serving as a basis for generating a dictionary, described in a markup language, such as an exTensible Markup Language (XML). XML is a markup language which can define an independent markup method in addition to a fixed markup method, used in HTML, and allows a document structure to be described in a simple format. Since tags can be independently defined, data can be described with a structure easy to understand for people, with the use of XML, and a flexible data structure is allowed.

A personal computer 12 reads the reference dictionary data described in XML from the dictionary data base 11, and converts it to generate dictionary data having body data and index data.

The personal computer 12 outputs, for example, to a WWW server 13 connected to the Internet 20, to various recording media, such as a magnetic disk 14, an optical disk 15, a magneto-optical disk 16, and a semiconductor memory 17 (including a memory stick (trademark)), or to the internal memory of an electronic dictionary 18 serving as a special reproduction apparatus, dictionary data having index data, which fits in the respective recording capacity, and stores the dictionary data therein.

The WWW server 13 allows the dictionary data to be downloaded, for example, to a PDA 21 which the user has or a personal computer 22, through the Internet 20, and provides a dictionary search service on a web page for the PDA 21 or the personal computer 22.

Various recording media, such as the magnetic disk 14, the optical disk 15, the magneto-optical disk 16, and the semiconductor memory 17, are mounted to the PDA 21 which the user has, the personal computer 22, or the electronic dictionary 18.

The electronic dictionary 18, the PDA 21, or the personal computer 22 searches the dictionary data downloaded from the WWW server 13 through the Internet 20 and stored in the internal memory, or the dictionary data recorded in a mounted recording medium (such as the magnetic disk 14, the optical disk 15, the magneto-optical disk 16, and the semiconductor memory 17) for an item input by the user according to a user's operation, and displays data on a display apparatus such as a display or a touch-sensitive panel.

The electronic dictionary 18 searches the dictionary data stored in advance in its inside or recorded inside by a user's process, or the dictionary data stored in a mounted recording medium for an item input by the user according to a user's operation, and displays the data of the item.

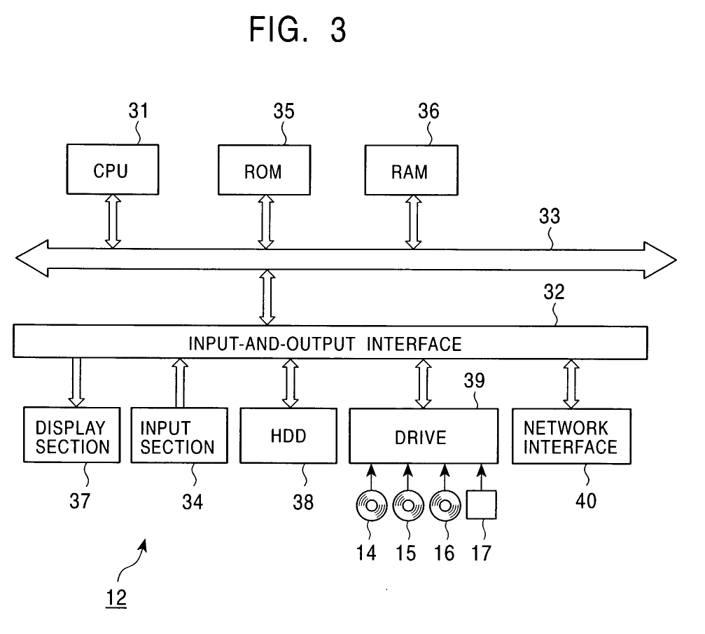

FIG. 3 is a block diagram showing the structure of the personal computer 12 shown in FIG. 2.

A central processing unit (CPU) 31 receives a signal corresponding to each of various types of instructions input by the user at an input section 34 through an input-and-output interface 32 and an internal bus 33, or a control signal transmitted from another personal computer (such as the personal computer 22) through a network interface 40, and executes various types of processing according to an input signal. A read-only memory (ROM) 35 stores a program used by the CPU 31 and basically fixed data in calculation parameters. A random-access memory (RAM) 36 stores a program used during execution of the CPU 31 and parameters being changed as required during the execution. The CPU 31, the ROM 35, and the RAM 36 are connected to each other by the internal bus 33.

The internal bus 33 is also connected to the input-and-output interface 32. The input section 34 is formed, for example, of a keyboard, a touch-sensitive pad, a jog dial, a mouse, and others, and is operated when the user inputs various instructions to the CPU 31. A display section 37 is formed, for example, of a cathode ray tube (CRT), a liquid-crystal display apparatus, and others, and displays various pieces of information by texts, images, and others.

A hard-disk drive (HDD) 38 drives a hard disk to record or reproduce a program to be executed by the CPU and information therein or therefrom. A magnetic disk 14, an optical disk 15, a magneto-optical disk 16, and a semiconductor memory 17 are mounted to a drive 39, as required, for data transfer.

The network interface 40 is connected, for example, to the WWW server 13 and to the electronic dictionary 18 with a predetermined cable, transfers information to and from these units, and accesses the dictionary data base 11 to search for necessary information to read it, inputs new data, and updates stored data.

The input section 34, the display section 37, the HDD 38, the drive 39, and the network interface 40 are connected to the CPU 31 through the input-and-output interface 32 and the internal bus 33.

Since the personal computer 22 which the user has, connected through the WWW server 13 and the Internet 20, has basically the same structure as the personal computer 12 described by referring to FIG. 3, a description thereof is omitted.

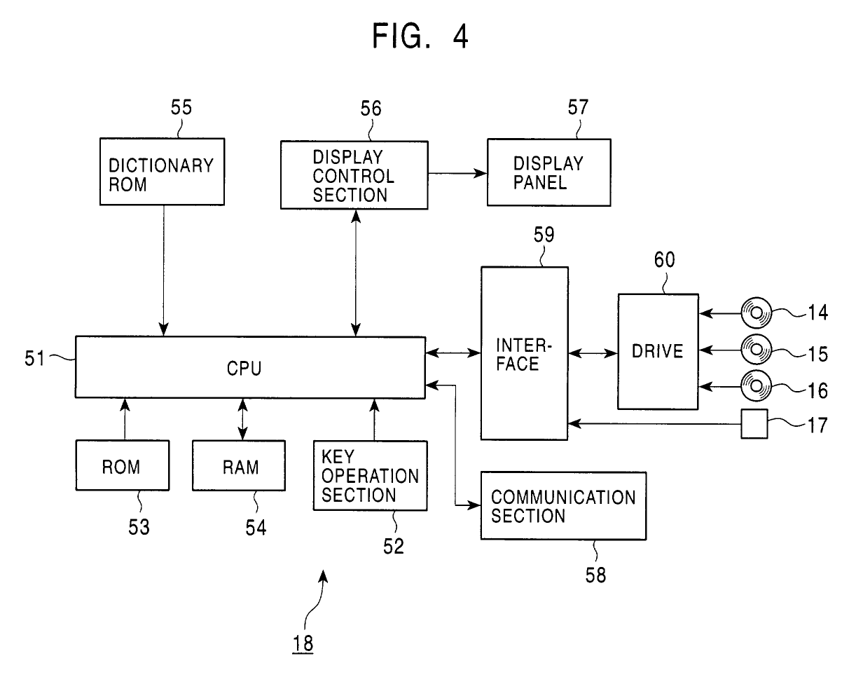

FIG. 4 is a block diagram showing the structure of the electronic dictionary 18 shown in FIG. 2.

A central processing unit (CPU) 51 executes various types of processing according to signals corresponding to various types of instructions input by the user at a key operation section 52, or control signals input through a communication section 58. A read-only memory (ROM) 53 stores a program used by the CPU 51 and basically fixed data in calculation parameters. A random-access memory (RAM) 54 stores a program used in execution of the CPU 51 and parameters being changed as required during the execution.

A dictionary ROM 55 stores dictionary data input from the personal computer 12 or downloaded from the WWW server 13 through the communication section 58.

A display control section 56 displays various pieces of information by texts, images, and others on a display panel 57 under the control of the CPU 51. The display panel 57 is formed, for example, of a cathode ray tube (CRT), a liquid-crystal display apparatus, and others, and displays various pieces of information by texts, images, and others under the control of the display control section 56.

An interface 59 is connected to a drive 60, and also to a semiconductor memory 17 for data transfer. A magnetic disk 14, an optical disk 15, or a magneto-optical disk 16 is mounted to the drive 60, as required, for data transfer.

The communication section 58 is connected to the personal computer 12, and accesses the WWW server 13 through the Internet 20 to search the WWW server 13 for necessary information to execute download processing for information transfer and for input-data update.

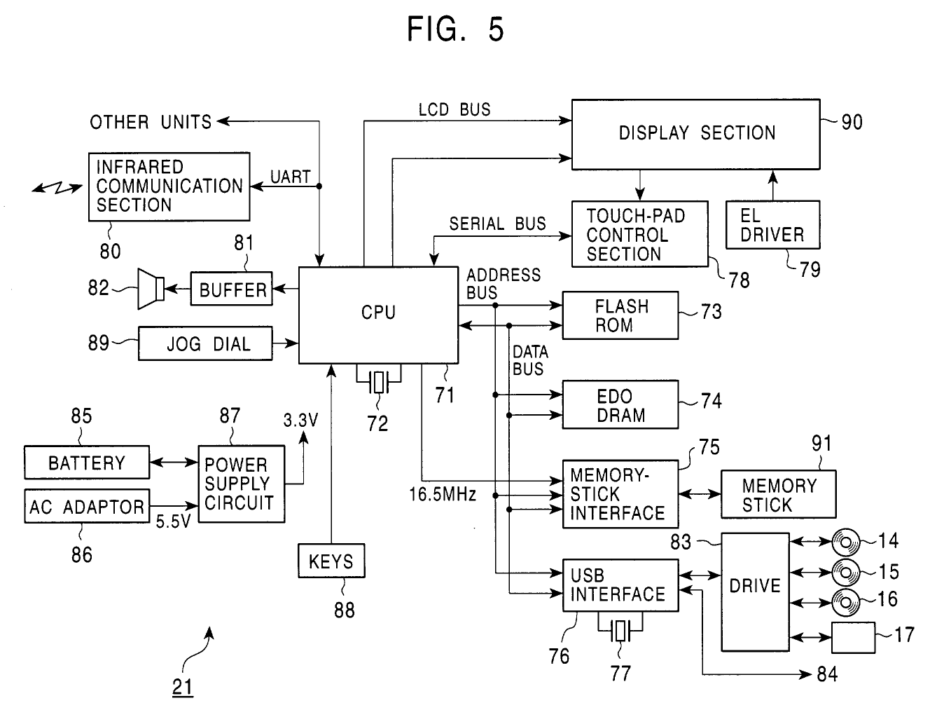

The internal structure of the PDA 21 will be described next by referring to FIG. 5.

A central processing unit (CPU) 71 executes various programs, such as an operating system stored in a flash read-only memory (ROM) 73, or an extended-data-out dynamic random access memory (EDO DRAM) 74 and a developed application program, in synchronization with a clock signal sent from an oscillator 72.

The flash ROM 73 is one type of electrically erasable programmable read-only memory (EEPROM), and generally stores a program used by the CPU 71 and basically fixed data in calculation parameters. The EDO DRAM 74 stores a program used in execution of the CPU 71 and parameters changed, as required, during the execution.

A memory stick interface 75 reads data from a memory stick 91 mounted to the PDA 21, and writes data sent from the CPU 71 into the memory stick 91.

A universal-serial-bus (USB) interface 76 receives data or a program from a drive 83 which is a USB unit connected and sends data sent from the CPU 71, to the drive 83 in synchronization with a clock signal sent from an oscillator 77. The USB interface 76 receives data or a program from a cradle 84 which is a USB unit connected and sends data sent from the CPU 71, to the cradle 84 in synchronization with the clock signal sent from the oscillator 77.

The cradle 84 is a docking station for connecting the PDA 21 to a personal computer with wire, and for executing data synchronization by a process so-called hot sync.

The USB interface 76 is also connected to the drive 83. The drive 83 reads data or a program recorded in a mounted magnetic disk 14, a mounted optical disk 15, a mounted magneto-optical disk 16, or a mounted semiconductor memory 17 to sent the data or the program to the CPU 71 or the EDO DRAM 74 connected through the USB interface 76. The drive 83 also records data or a program sent from the CPU 71 in the mounted magnetic disk 14, the mounted optical disk 15, the mounted magneto-optical disk 16, or the mounted semiconductor memory 17.

The PDA 21 can also be connected to a portable telephone or a personal handyphone system (PHS), and can further access the WWW server 13 through the Internet 20.

The flash ROM 73, the EDO DRAM 74, the memory-stick interface 75, and the USB interface 76 are connected to the CPU 71 through an address bus and a data bus.

A display section 90 receives data from the CPU 71 through an LCD bus and displays an image or a character corresponding to the received data. When a touch pad provided at an upper portion of the display section 90 is operated, a touch-pad control section 78 receives data (for example, data indicating the coordinates of a touched point) corresponding to the operation from the display section 90, and sends a signal corresponding to the received data to the CPU 71 through a serial bus.

An electroluminescence driver 79 operates an electroluminescence device provided at a rear side of a liquid-crystal display part of the display section 90, and controls the display brightness of the display section 90.

An infrared communication section 80 sends data received from the CPU 71 to another unit (not shown) through a universal asynchronous receiver/transmitter (UART) with an infrared beam, and receives data sent from another unit with an infrared beam to send it to the CPU 71. In other words, the PDA 21 can communicate with other units through the UART.

An audio reproduction section 82 is formed of a speaker, a decoding circuit for audio data, and others, and decodes audio data stored in advance or audio data received through the Internet 20 to reproduce the audio data and output sound. For example, the audio reproduction section 82 reproduces audio data sent from the CPU 71 through a buffer 81 to output sound corresponding to the data.

Keys 88 include, for example, an input key, and are used by the user to input various instructions to the CPU 71.

A jog dial 89 sends data corresponding to a rotation operation or a pressing operation toward a body side, to the CPU 71.

A power supply circuit 87 converts the voltage of power supplied from a mounted battery 85 or a connected alternating-current (AC) adaptor 86 and supplies power to the CPU 71, the audio reproduction section 82, and others.

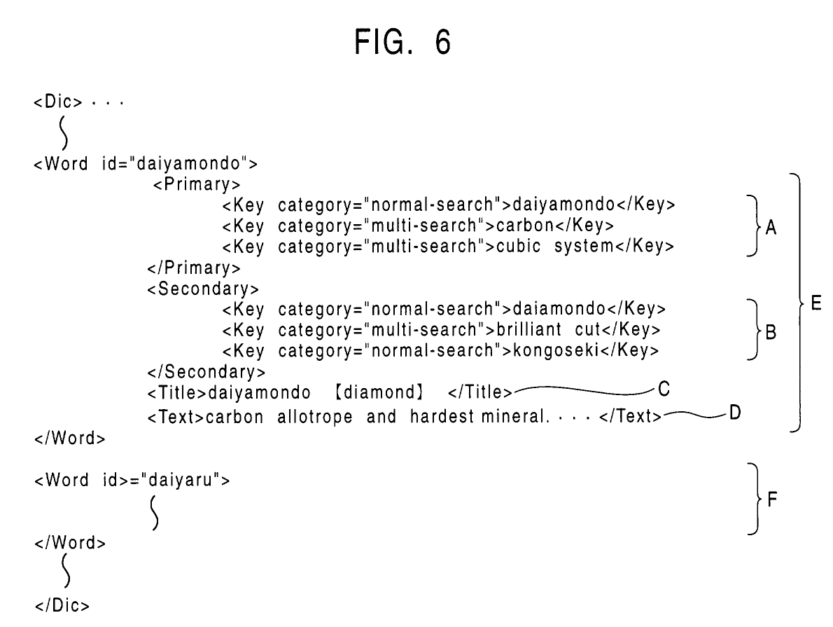

The reference dictionary data recorded in the dictionary data base 11 will be described next by referring to FIG. 6.

The reference dictionary data is described in a markup language such as XML. One dictionary starts with <Dic> and ends with </Dic>. The data of each item is placed in a dictionary at an area starting with <Word id=“xxxx”> and ending with </Word> (an area indicted by E or F in FIG. 6).

Each item (for example, each headword in a dictionary) has a keyword described for each level, and each keyword includes a search category in which the keyword is used. Specifically, for each item, an essential keyword is described in an area (indicated by A in FIG. 6) enclosed by <Primary> and </Primary>, and a keyword which should be added, if possible, is described in an area (indicated by B in FIG. 6) enclosed by <Secondary> and </Secondary>. Each keyword is described in a format of <Key category=“category_name”>keyword (each item)</Key> together with a search category in which the keyword is used, such as forward-match search, backward-match search, complete-match search, and AND search.

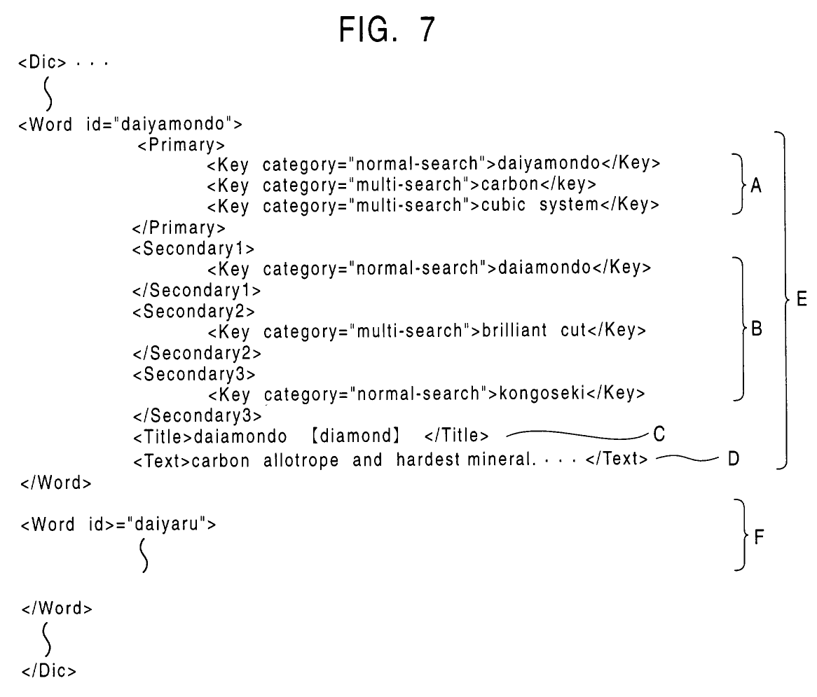

An essential keyword, indicated by “Primary,” needs to be described in all dictionaries generated by the use of the reference dictionary data. In contrast, a keyword indicated by “Secondary” may be described depending on the capacity of a recording medium in which the dictionary data is recorded. In order to be able to determine whether a keyword indicated by “Secondary” is described by a process described later, keywords may be described in the order of importance in an area enclosed by <Secondary> and </Secondary>, so that the keywords can be selected with priority, as shown in FIG. 6. Alternatively, as shown in FIG. 7, a plurality of areas enclosed by <Secondary> and </Secondary> may be provided, so that a keyword described in an area enclosed by <Secondary> and </Secondary> having an upper level can be selected with priority.

In FIG. 6 and FIG. 7, “normal-search” corresponding to forward-match search and “multi-search” corresponding to AND search are used as search categories. Other categories may be used, and classification may be performed with the use of three or more categories.

In each item, following keywords indicated by “Primary” and “Secondary,” the tile of the item (indicated by C in the figures) is described between <Title> and </Title>, and then, a body (indicated by D in the figures) is described between <Text> and </Text>. A plurality of bodies each of which is described between <Text> and </Text> may be provided.

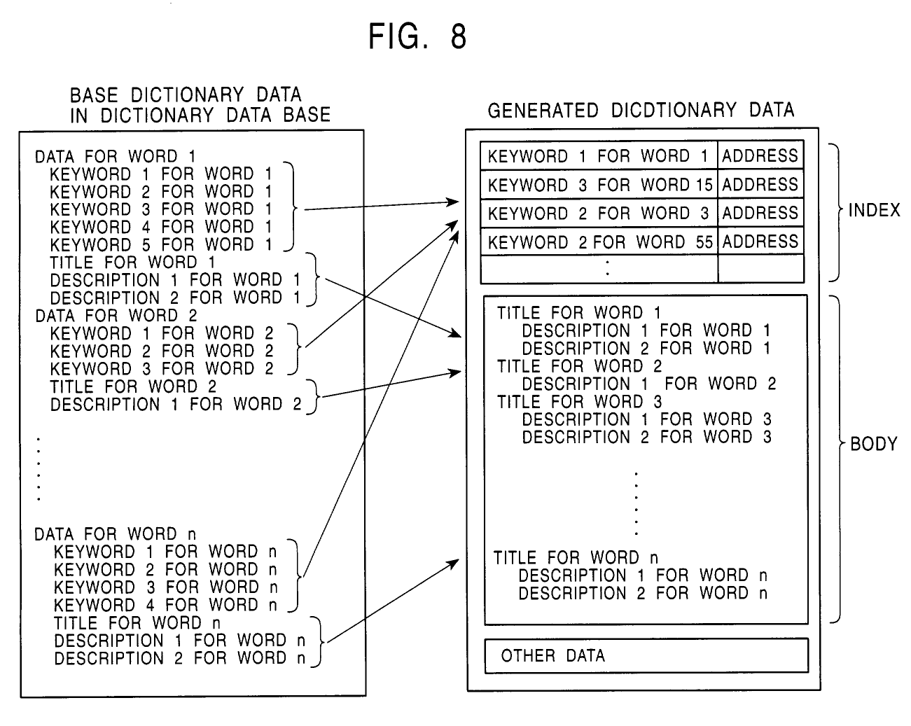

The personal computer 12 generates dictionary data divided into an index part and an body part for an easy search process, as shown in FIG. 8, by using the reference dictionary data described by referring to FIG. 6 and FIG. 7.

The index part shows keywords used for searching for words, and the addresses of the words in the body part. The body part shows the titles and descriptions of the words.

Since the data capacity of the index data needs to be determined by the recording capacity of a recording medium in which the dictionary data is recorded, as described above, the CPU 31 of the personal computer 12 separates the keywords from body texts in the reference dictionary data to generate a dictionary data, and determines the data capacity of the index data according to the recording capacity of a recording medium in which the dictionary data is to be recorded. Then, the CPU 31 selects keywords included in the index data according to the levels of the keywords described by referring to FIG. 6 and FIG. 7 so that the keywords fit in the data capacity to generate the dictionary data.

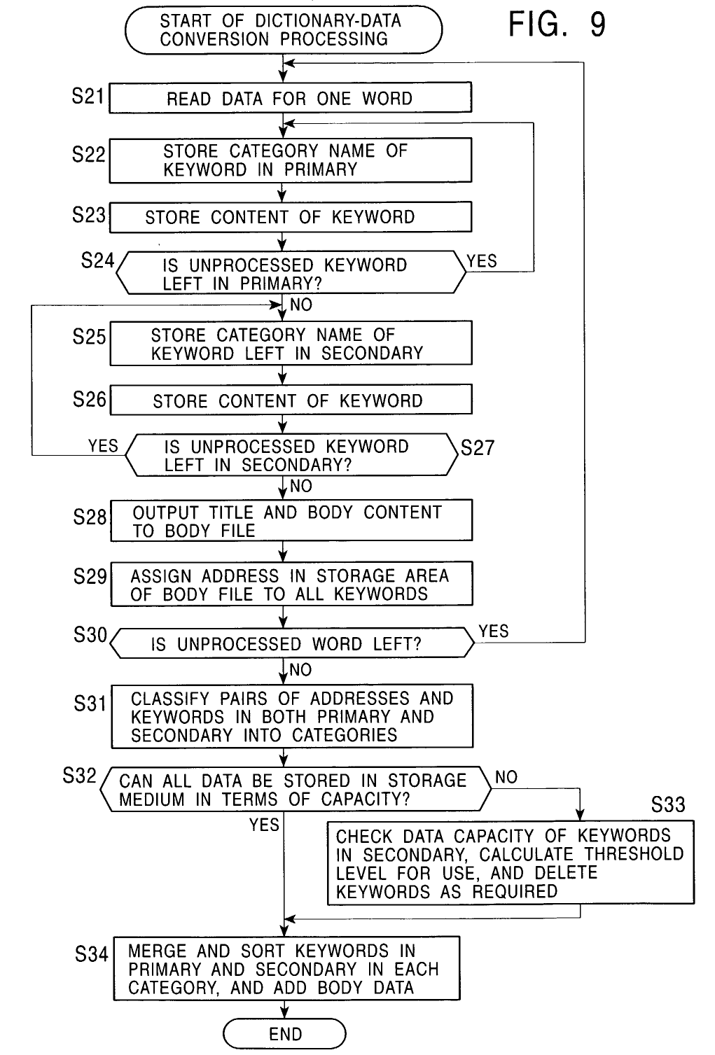

The dictionary-data conversion processing executed by the personal computer 12 will be described next by referring to a flowchart shown in FIG. 9.

In step S21, the CPU 31 reads one-word data, that is, data included in an area enclosed by <Word_id=“xxxx”> and </Word> in FIG. 6 and FIG. 7, in the reference dictionary data corresponding to a dictionary to which the conversion processing is applied, from the dictionary data base 11 through the internal bus 33, the input-and-output interface 32, and the network interface 40.

In step S22, the CPU 31 pays attention to a keyword which has not yet been processed among keywords described in a form of <Key category=“category_name”>item_name</Key> in keywords in “Primary,” that is, areas (indicated by A in FIG. 6 or FIG. 7) each enclosed by <Primary> and </Primary>, and stores the category name of the keyword in the RAM 36.

In step S23, the CPU 31 associates the content of the keyword to which attention was paid in step S22, that is, the “item name” in the form of <Key category=“category_name”>item_name</Key>, with the category name stored in step S22, and stores in the RAM 36.

In step S24, the CPU 31 determines whether there remains a keyword not yet processed in “Primary,” that is, areas (indicated by A in FIG. 6 or FIG. 7) enclosed by <Primary> and </Primary>. When it is determined in step S24 that there remains a keyword not yet processed in “primary,” the processing returns to step S22, and subsequent processes are repeated.

When it is determined in step S24 that there remains no keyword not yet processed in “Primary,” that is, all keywords in “Primary” have been processed, the CPU 31 pays attention to a keyword which has not yet been processed among keywords described in a form of <Key category=“category_name”>item_name</Key> in keywords in “Secondary,” that is, areas (indicated by B in FIG. 6 or FIG. 7) each enclosed by <Secondary> and </Secondary>, and stores the category name of the keyword in the RAM 36, in step S25.

In step S26, the CPU 31 associates the content of the keyword to which attention was paid in step S25, that is, the “item name” in the form of <Key category=“category_name”>item_name</Key>, with the category name stored in step S25, and stores in the RAM 36.

In step S27, the CPU 31 determines whether there remains a keyword not yet processed in “Secondary.” When it is determined in step S27 that there remains a keyword not yet processed in “Secondary,” the processing returns to step S25, and subsequent processes are repeated.

When it is determined in step S27 that there remains no keyword not yet processed in “Secondary,” that is, that all keywords included in words being process have been processed, the CPU 31 outputs the title and the content of the body (information indicated by C and D in FIG. 6 or FIG. 7) to a body file prepared in advance in the RAM 36, in step S28.

In step S29, the CPU 31 associates the address (assuming here a relative address) of the storage area of the body file in the RAM 36 with all the keywords stored in the RAM 36 in step S23 and in step S26 as their address, and stores it.

In step S30, the CPU 31 determines whether there remains a word which has not yet been processed in the reference dictionary data being processed. When it is determined in step S30 that there remains a word not yet processed in the reference dictionary data being processed, the processing returns to step S21, and subsequent processes are repeated.

When it is determined in step S30 that there remains no word not yet processed in the reference dictionary data being processed, the CPU 31 classifies in step S31 pairs of keywords and addresses into categories for both keywords in “Primary” and “Secondary” stored in the RAM 36.

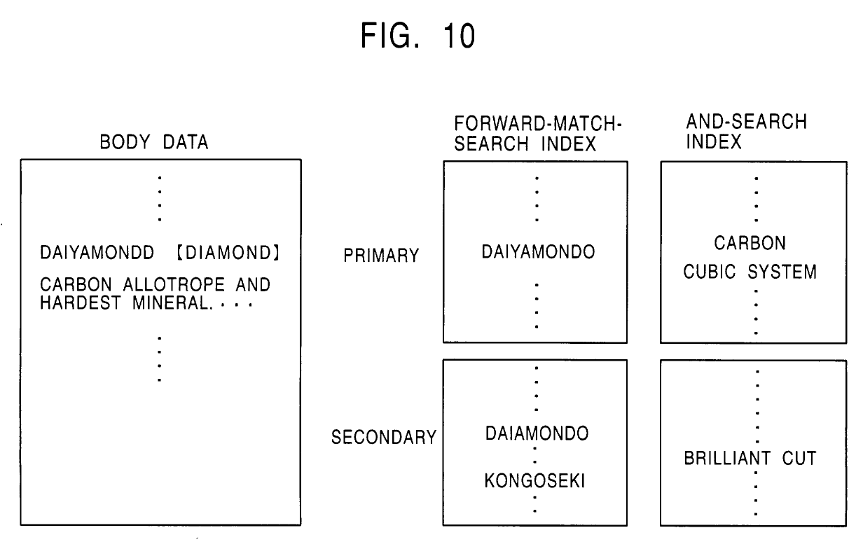

FIG. 10 is a view showing the body data generated. in step S28 and keywords classified in step S31 for the reference dictionary data described by referring to FIG. 6. Forward-match search and AND search are provided as keyword categories, and keywords are divided into “Primary” and “Secondary” in each category. Therefore, keywords are divided into four types.

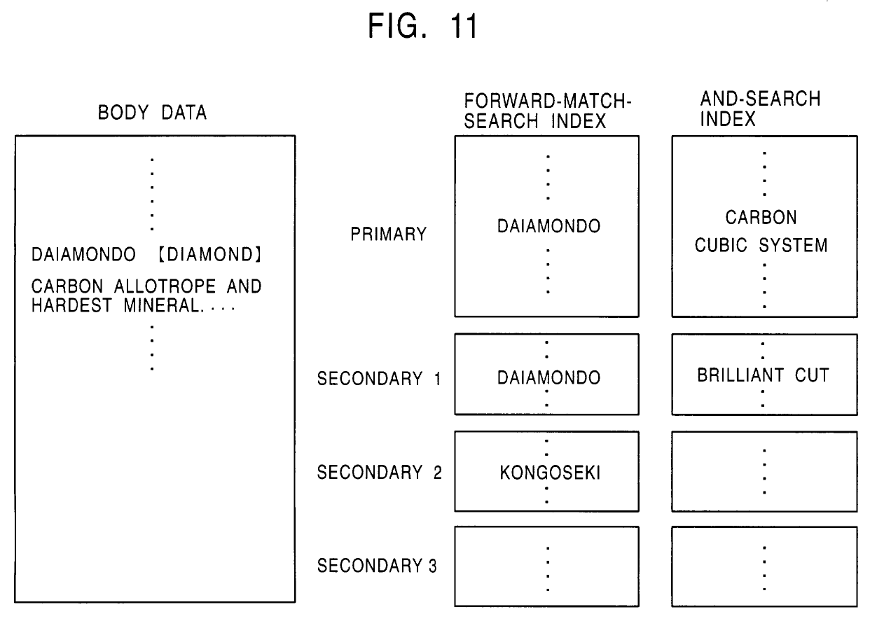

FIG. 11 is a view showing the body data generated in step S28 and keywords classified in step S31 for the reference dictionary data described by referring to FIG. 7. Since keywords in “Secondary” have been classified by the degree of importance in advance in the reference dictionary data described by referring to FIG. 7, the keywords in “Secondary” may be divided into a plurality of groups when pairs of keywords and addresses are classified into categories in step S30, as shown in FIG. 11.

In step S32, the CPU 31 determines whether all data fits in a storage medium in which dictionary data generated by the conversion processing is to be recorded, or in a memory in an apparatus (such as the WWW server 13, the magnetic disk 14, the optical disk 15, the magneto-optical disk 16, the semiconductor memory 17, the electronic dictionary 18, the PDA 21, or the personal computer 22, described by referring to FIG. 2) in terms of capacity.

When it is determined in step S32 that all data cannot fit in the storage medium in terms of capacity, the CPU 31 check the data capacity required for the secondary keywords, calculates a threshold level for use, and deletes secondary keywords, if necessary, according to a result of calculation, in step S33.

When it is determined in step S32 that all data can fit in the storage medium in terms of capacity, or after the process of step S33 has been finished, the CPU 31 merges and sorts keywords in “Primary” and “Secondary” in each category, and adds body data thereto to generate dictionary data in the form described by referring to FIG. 8, in step S34. The processing is finished.

With such simple processing, dictionary data having index data which has a data amount suited to a recording capacity can be generated from one set of reference dictionary data. In the above embodiment, the data amount of index data is determined according to the capacity of an output-destination recording medium or that of a memory inside each apparatus. To handle a case in which a plurality of sets of dictionary data is stored in one recording medium, for example, it may be possible that the administrator for generating dictionary data inputs the amount of the dictionary data to be generated by using the input section 34 to specify it.

The generated dictionary data is stored in a recording medium, such as the magnetic disk 14, the optical disk 15, the magneto-optical disk 16, or the semiconductor memory 17, or recorded in the dictionary ROM 55 inside the electronic dictionary 18, and distributed to users. Alternatively, the generated dictionary data is output to the WWW server 13, and is downloaded through the Internet 20 to the PDA 21, which the user has, or to the personal computer 22 and used (in this case, sets of dictionary data having different data amounts for downloading apparatuses need to be stored in the WWW server 13), or is provided as a web dictionary search service.

In the processing described by referring to FIG. 9, pairs of keywords and addresses are classified in each category, the capacity of a recording destination of converted dictionary data is checked, and keywords in “Secondary” are selected (deleted so that the remaining secondary keywords fit in) according to a result of checking. It may be possible that the capacity of a recording destination of converted dictionary data is checked first, and then, pairs of keywords and addresses are classified in each category. Especially when reference dictionary data has the form described by referring to FIG. 7, in which keywords in “Secondary” are separately described in each level, it may be possible that the recording capacity of a recording destination of converted dictionary data is checked first, and then, a conversion process is executed according to the capacity.

According to the structure of the reference dictionary data described by referring to FIG. 6 or FIG. 7, the data size of converted dictionary data can be flexibly changed according to the recording capacity of an output destination of the converted dictionary data, such as a recording medium, including a magnetic disk 14, an optical disk 15, a magneto-optical disk 16, or a semiconductor memory 17, the electronic dictionary 18, the WWW server 13, the PDA 21, or the personal computer 22.

In addition, according to the structure of the reference dictionary data described by referring to FIG. 6 or FIG. 7, it is easy to change the contents of the reference dictionary data and keywords. Even when the body data needs to be changed, added, or deleted, data does not need to be largely changed (addition, deletion, or modification is applied to only necessary portion), unlike conventional electronic-dictionary revision work. Even if modification is applied, the process for generating dictionary data to be actually distributed, from the reference dictionary data is not affected at all.

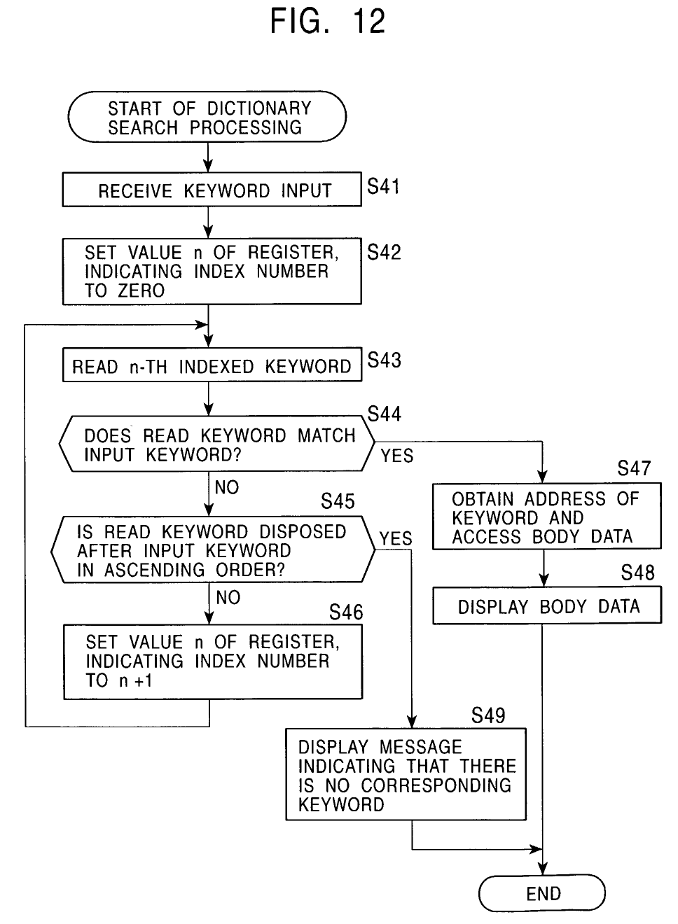

Dictionary search processing to be executed by the electronic dictionary 18 to which a recording medium which has stored the dictionary data generated by the processing described by referring to the flowchart shown in FIG. 9 is mounted or in which the dictionary data has been stored in the dictionary ROM 55 will be described next by referring to a flowchart shown in FIG. 12. Complete-match search will be described.

In step S41, the CPU 51 receives a keyword input by the user from the key operation section 52.

In step S42, the CPU 51 sets the value “n” of a register indicating an index number in the RAM 54 to zero.

The CPU 51 reads the n-th keyword in index data from the dictionary data stored in the dictionary ROM 55 or the dictionary data recorded in the mounted recording medium, in step S43, and determines in step S44 whether the read keyword matches the input keyword.

When it is determined in step S44 that the read keyword does not match the input keyword, the CPU 51 determines in step S45 whether the keyword read from the dictionary ROM 55 or the keyword read from the recording medium through the interface 59 is disposed after the input keyword in an ascending order.

When it is determined in step S45 that the read keyword is not disposed after the input keyword in the ascending order, that is, that the read keyword is disposed before the keyword in the ascending order, the CPU 51 increments the value “n” of the register indicating the index number in the RAM 54, by one, the processing returns to step S43, and subsequent processes are repeated.

When it is determined in step S44 that the read keyword matches the input keyword, the CPU 51 obtains the address of the matched keyword and accesses an area where the corresponding body data is recorded in the dictionary data in step S47. Then, in step S48, the CPU 51 controls the display control section 56 to display the accessed body data on the display panel 57. The processing is finished.

When it is determined in step S45 that the read keyword is disposed after the input keyword in the ascending order, the CPU 51 controls the display control section 56 in step S49 to display a message indicating on the display panel that there is no corresponding keyword. Then, the processing is finished.

With such processing, the complete-match search processing is executed with the use of the generated dictionary data. When forward-match search is executed, it is necessary for the process of step S44 to determine whether the read keyword matches the input keyword from the first character toward the last character. When backward-match search is executed, it is necessary to determine whether the read keyword matches the input keyword from the last character toward the first character. When AND search is executed, it is necessary to determine whether the input keyword matches index data included in an AND-search index.

The electronic dictionary 18 has been taken as an example in the above embodiment. The same processing is executed when the WWW server 13, the PDA 21, or the personal computer 22, described by referring to FIG. 2, has dictionary data in its inside, or when a recording medium which has recorded dictionary data, such as a magnetic disk 14, an optical disk 15, a magneto-optical disk 16, and a semiconductor memory 17, is mounted.

The electronic dictionary 18 has been taken as an example in the above embodiment. The present invention can be applied to all electronic publications which require indexes, such as encyclopedias and technical books.

The above-described series of processing can also be executed by software. A program constituting the software is installed from a recording medium into a computer which is built in special hardware, or into a machine, such as a general-purpose personal computer, which can execute various functions by installing various programs.

The recording medium is formed of a package medium, such as a magnetic disk 14 (including a flexible disk), an optical disk 15 (including compact disk read only memory (CD ROM) and a digital versatile disk (DVD)), a magneto-optical disk 16 (including Mini Disk (trademark) (MD)), or a semiconductor memory 17, into which the program is recorded and which is distributed to provide the user with the program separately from the computer, as shown in FIG. 2 to FIG. 5.

In the present specification, steps describing the program recorded in a recording medium include not only processing to be executed in a time-sequential manner in a described order but processing which is not necessarily executed time-sequentially but is executed in parallel or independently.

In the present specification, a system refers to an entire apparatus formed of a plurality of units.

What is claimed is:

1. An information processing apparatus for converting first information described in a predetermined format to second information formed of index data and body data, and for outputting it, comprising:
obtaining means for obtaining the first information;
extraction means for extracting a plurality of third information corresponding to a keyword and fourth information corresponding to the body data, from the first information obtained by the obtaining means;
detection means for detecting the recording capacity of another information processing apparatus or a recording medium to which the second information is to be output;
determination means for determining the level of importance for each of the plurality of third information;
selection means for selecting third information from the plurality of third information according to the result of detection performed by the detection means and the result of determination performed by the determination means, such that the total amount of the third information and the fourth information is equal to or less than the recording capacity of the another information processing apparatus or the recording medium;
generation means for setting the third information selected by the selection means to the index data, and for adding the fourth information thereto to generate the second information; and
output means for outputting the second information generated by the generation means to the another information processing apparatus or to the recording medium.

2. An information processing apparatus according to claim 1,
wherein the third information is classified in advance by the level of importance, includes predetermined information corresponding to classification, and is included in the first information; and
the determination means determines the level of importance of the third information according to the predetermined information included in the third information.

3. An information processing apparatus according to claim 1,
wherein the third information is arranged in advance in the descending order of the levels of importance; and
the determination means determines the level of importance of the third information according to the order of the third information.

4. An information processing apparatus according to claim 1,
wherein the index data is used by the another information processing apparatus, which obtains the second information, for searching the body data; and
the third information is classified in advance by the method of search, includes predetermined information corresponding to classification, and is included in the first information.

5. An information processing apparatus according to claim 1, wherein the first information is described in a markup language.

6. An information processing apparatus according to claim 5, wherein the extraction means extracts the plurality of third information and the fourth information from the first information obtained by the obtaining means, according to tag information indicating the type of information, attached to each of the plurality of third information corresponding to the keyword and the fourth information corresponding to the body data.

7. An information processing method for an information processing apparatus which converts first information described in a predetermined format to second information formed of index data and body data, and outputs it, comprising:
an obtaining step of obtaining the first information;
an extraction step of extracting a plurality of third information corresponding to a keyword and fourth information corresponding to the body data, from the first information obtained by a process in the obtaining step;
a detection step of detecting the recording capacity of another information processing apparatus or a recording medium to which the second information is to be output;
a determination step of determining the level of importance for each of the plurality of third information;
a selection step of selecting third information from the plurality of third information according to the result of detection performed by a process in the detection step and the result of determination performed by a process in the determination step, such that the total amount of the third information and the fourth information is equal to or less than the recording capacity of the another information processing apparatus or the recording medium;
a generation step of setting the third information selected by a process in the selection step to the index data, and of adding the fourth information thereto to generate the second information; and
an output step of outputting the second information generated by a process in the generation step to the another information processing apparatus or to the recording medium.

8. A recording medium storing a computer-readable program for an information processing apparatus which converts first information described in a predetermined format to second information formed of index data and body data, and outputs it, the program comprising:
an obtaining step of obtaining the first information;
an extraction step of extracting a plurality of third information corresponding to a keyword and fourth information corresponding to the body data, from the first information obtained by a process in the obtaining step;
a detection step of detecting the recording capacity of another information processing apparatus or a recording medium to which the second information is to be output;
a determination step of determining the level of importance for each of the plurality of third information;
a selection step of selecting third information from the plurality of third information according to the result of detection performed by a process in the detection step and the result of determination performed by a process in the determination step, such that the total amount of the third information and the fourth information is equal to or less than the recording capacity of the another information processing apparatus or the recording medium;
a generation step of setting the third information selected by a process in the selection step to the index data, and of adding the fourth information thereto to generate the second information; and
an output step of outputting the second information generated by a process in the generation step to the another information processing apparatus or to the recording medium.

9. A computer-executable program for an information processing apparatus which converts first information described in a predetermined format to second information formed of index data and body data, and outputs it, comprising:
an obtaining step of obtaining the first information;
an extraction step of extracting a plurality of third information corresponding to a keyword and fourth information corresponding to the body data, from the first information obtained by a process in the obtaining step;
a detection step of detecting the recording capacity of another information processing apparatus or a recording medium to which the second information is to be output;
a determination step of determining the level of importance for each of the plurality of third information;
a selection step of selecting third information from the plurality of third information according to the result of detection performed by a process in the detection step and the result of determination performed by a process in the determination step, such that the total amount of the third information and the fourth information is equal to or less than the recording capacity of the another information processing apparatus or the recording medium;
a generation step of setting the third information selected by a process in the selection step to the index data, and of adding the fourth information thereto to generate the second information; and
an output step of outputting the second information generated by a process in the generation step to the another information processing apparatus or to the recording medium.

10. An electronic-publishing-data providing system comprising:
a recording apparatus for recording first information described in a predetermined format;
an information processing apparatus for converting the first information described in the predetermined format to second information formed of index data and body data; and
a recording medium for receiving and recording the second information sent from the information processing apparatus,
wherein the recording apparatus comprises:
first recording means for recording the first information; and
output means for outputting the first information recorded by the first recording means, and
wherein the first information includes a plurality of items each formed of a plurality of third information corresponding to a keyword and fourth information corresponding to the body data;
tag information indicating the type of information is added to the plurality of third information and the fourth information; and
the plurality of third information is classified in advance by the level of importance, and includes a predetermined information corresponding to classification,
the information processing means comprises:
obtaining means for obtaining the first information from the recording apparatus;
extraction means for extracting the plurality of third information and the fourth information according to the tag information, from the first information obtained by the obtaining means;
detection means for detecting the recording capacity of the recording medium;
determination means for determining the level of importance for each of the plurality of third information according to the predetermined information corresponding to the classification;
selection means for selecting third information from the plurality of third information according to the result of detection performed by the detection means and the result of determination performed by the determination means, such that the total amount of the third information and the fourth information is equal to or less than the recording capacity of the recording medium;
generation means for setting the third information selected by the selection means to the index data, and for adding the fourth information thereto to generate the second information; and
output means for outputting the second information generated by the generation means to the recording medium, and
the recording medium comprises second recording means for recording the second information output from the output means.

11. An electronic-publishing-data providing system according to claim 10, wherein the recording medium is provided inside another information processing apparatus.

12. An electronic-publishing-data providing system according to claim 10, wherein the first information is described in a markup language.
